(19) United States
(12) Patent Application Publication
(10) Pub. No.: US 2026/0013654 A1
(43) Pub. Date: Jan. 15, 2026

(54) HANGING PLANT WATER SAUCER SUPPORT ASSEMBLY

(71) Applicant: Bonnie Thompson-Jamieson, Manitou Springs, CO (US)

(72) Inventor: Bonnie Thompson-Jamieson, Manitou Springs, CO (US)

(21) Appl. No.: 18/770,288

(22) Filed: Jul. 11, 2024

(51) Int. Cl. A47G 7/04; A01G 9/04

(52) U.S. Cl. CPC A47G 7/044; A01G 9/04

(57) ABSTRACT

A hanging plant water saucer support assembly includes a support ring and a plurality of support assemblies. The support ring is designed to hold a water saucer by an outer rim thereof. Each of the plurality of support assemblies includes an elongated member, a first connecting device positioned at a first end of the elongated member and detachably connecting the support ring and the elongated member, and a second connecting device positioned at a second end of the elongated member and designed to detachably connect to a hanging plant to suspend the support ring and a water saucer held thereby from a hanging plant adjacent a bottom portion thereof to catch water.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hanging plant accessories and more particularly pertains to a new hanging plant water saucer support assembly to allow a user to hang a water saucer under a pot of a hanging plant to catch water leaking from the bottom or over the sides of the pot.

### (2) Description of Related Art Including Information Disclosed Under 37 CFR 1.97 and 1.98

The prior art relates to hanging plant accessories. The prior art, as best understood, does not disclose a saucer accessory for hanging plant baskets that is comprised of a bottom saucer for a plant pot that contains a plurality of wire, plastic, or rope securing members which are used to secure the saucer to the bottom of a hanging plant basket or pot.

### BRIEF SUMMARY OF THE INVENTION

An embodiment of the disclosure meets the needs presented above in a hanging plant water saucer support assembly generally comprising a support ring and a plurality of support assemblies. The support ring is designed to hold a water saucer by an outer rim thereof. Each of the plurality of support assemblies includes an elongated member, a first connecting device positioned at a first end of the elongated member and detachably connecting the support ring and the elongated member, and a second connecting device positioned at a second end of the elongated member and designed to detachably connect to a hanging plant to suspend the support ring and a water saucer held thereby from a hanging plant adjacent a bottom portion thereof to catch water.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a hanging plant water saucer support assembly according to an embodiment of the disclosure.

FIG. 2 is a side view of an embodiment of the disclosure.

FIG. 3 is a close-up view of a portion of an embodiment of the disclosure.

FIG. 4 is a perspective view of an embodiment of the disclosure in use.

FIG. 5 is a perspective view of an embodiment of the disclosure in use.

FIG. 6 is a perspective view of an embodiment of the disclosure.

### DETAILED DESCRIPTION OF THE INVENTION

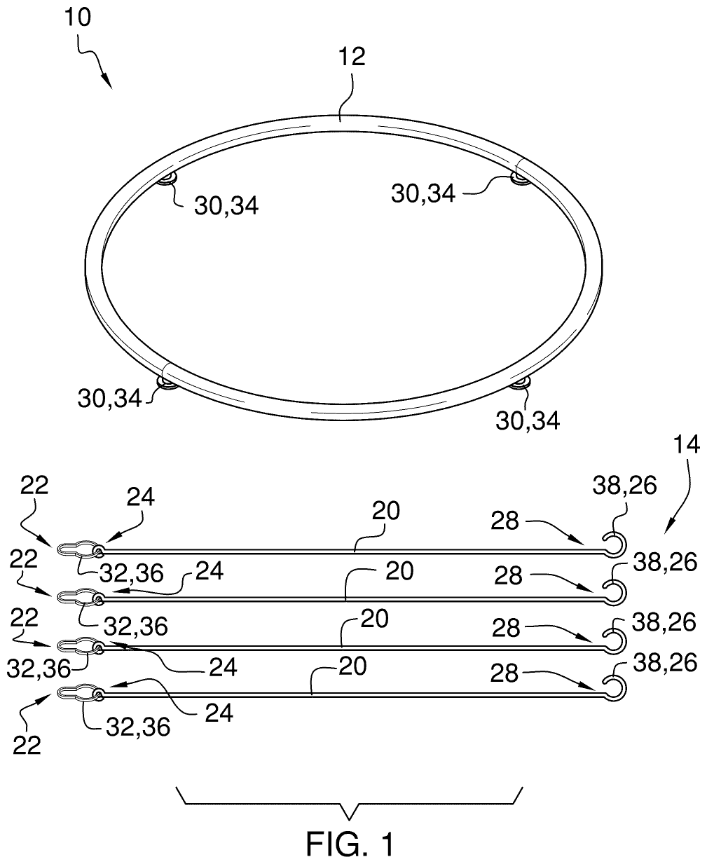

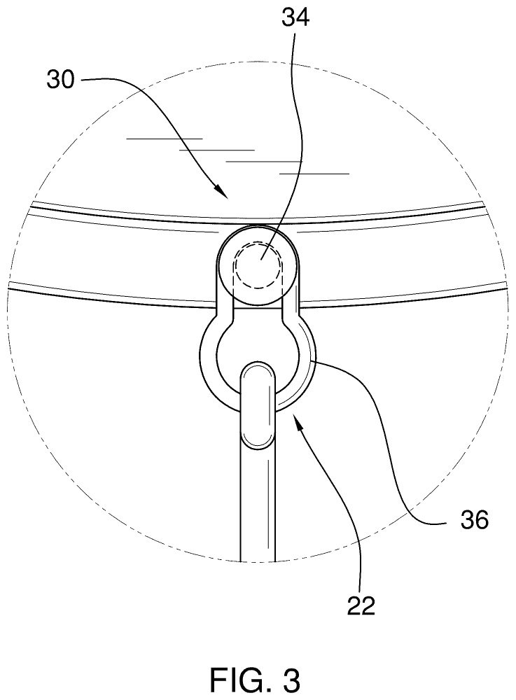

With reference now to the drawings, and in particular to FIGS. 1 through 6 thereof, a new hanging plant water saucer support assembly embodying the principles and concepts of an embodiment of the disclosure and generally designated by the reference numeral 10 will be described.

As best illustrated in FIGS. 1 through 6, the hanging plant water saucer support assembly 10 generally comprises a support ring 12 and a plurality of support assemblies 14. The support ring 12 is designed to hold a water saucer 16 by an outer rim 18 thereof. Each of the plurality of support assemblies 14 includes an elongated member 20, a first connecting device 22 positioned at a first end 24 of the elongated member 20 and detachably connecting the support ring 12 and the elongated member 20, and a second connecting device 26 positioned at a second end 28 of the elongated member 20 and designed to detachably connect to a hanging plant 70 to suspend the support ring 12 and a water saucer 16 held thereby from a hanging plant 70 adjacent a bottom portion thereof to catch water.

The figures show exemplary embodiments of the hanging plant water saucer support assembly 10, and it should be understood that modifications and variations thereof are within the scope of the disclosure. With reference to the exemplary embodiment shown in FIG. 1, the first connecting device 22 includes a first connecting member 30 attached to the support ring 12 and a second connecting member 32 attached to the first end 24 of the elongated member 20. The first connecting member 30 includes a post 34 and the second connecting member 32 includes a clip structure 36 designed to detachably and pivotably clip onto the post 34. Other detachable connection types such as snaps, buttons, and magnets are within the scope of the disclosure.

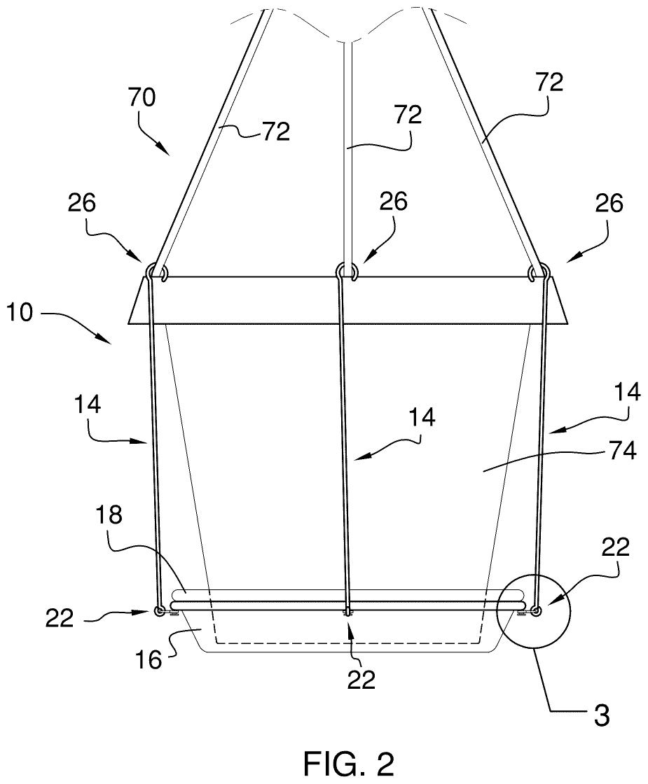

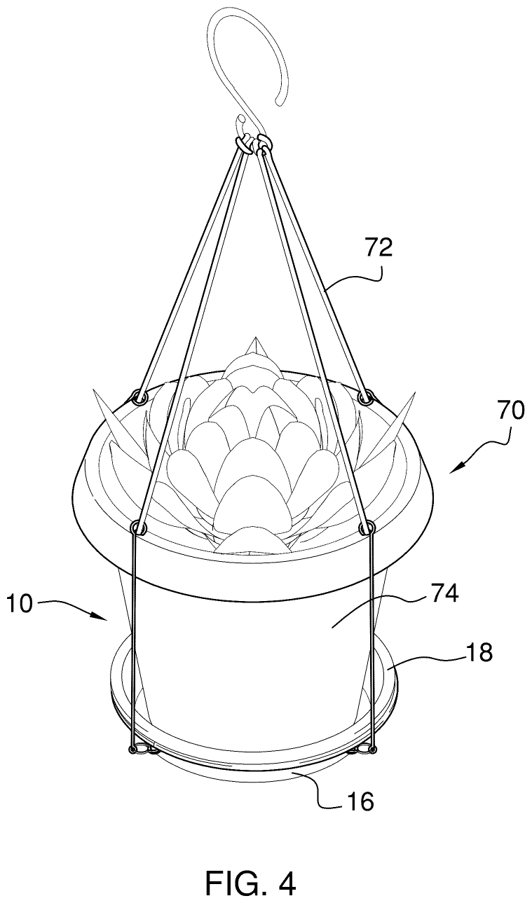

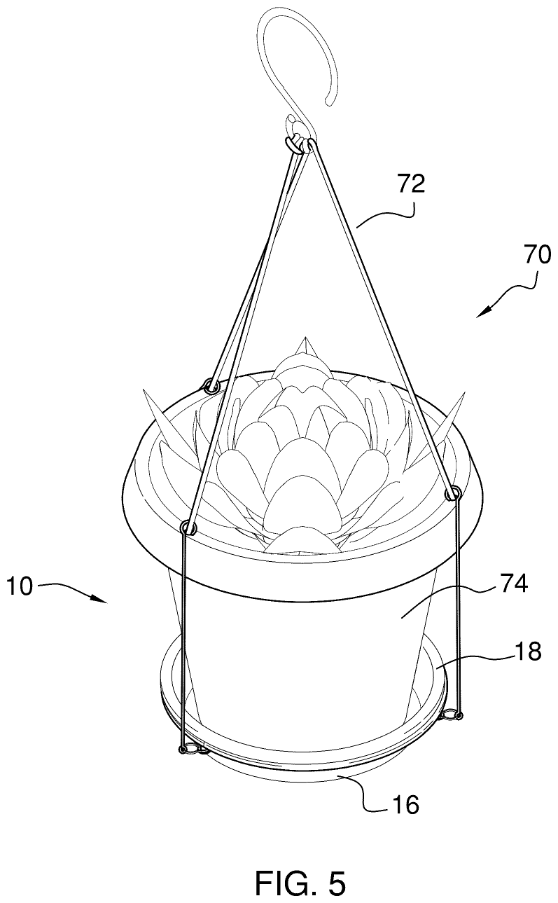

The second connecting device 26 includes a hook structure 38 designed to hang on the hanging plant 70. As shown in FIG. 2, the hook structure 38 includes a round hook designed to hook onto a support wire or rope 72 of a hanging structure attached to an upper portion of a pot 74 of a hanging plant 70. In another possible embodiment, the hook structure 38 could be designed to hook onto the rim of the pot 74. As shown in FIGS. 4 and 5, there can be three or four support assemblies 14 to match the number of support wires or ropes 72 of the hanging plant 70, though more support assemblies 14 could be used.

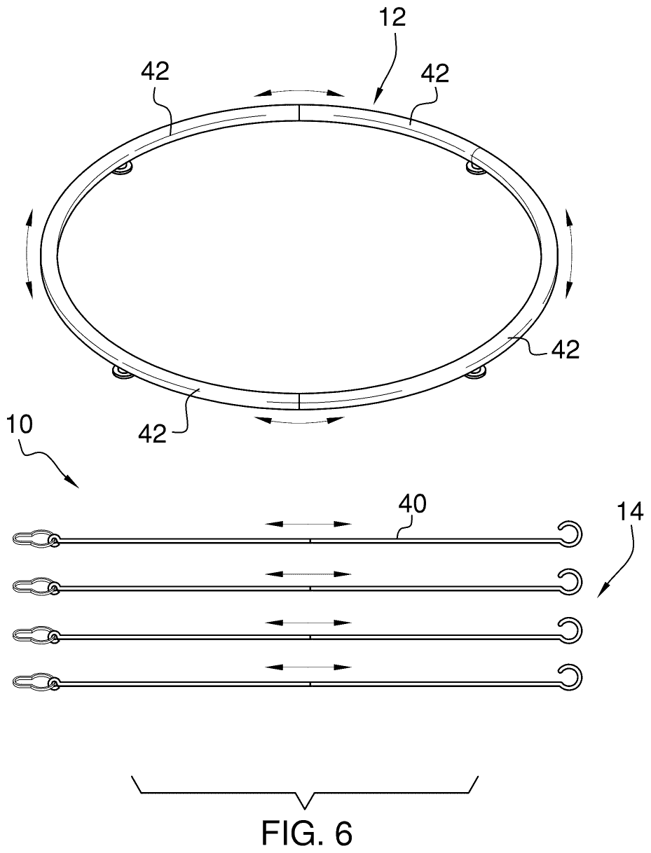

The elongated member 20 can be designed in different ways. For example, the elongated member 20 could be a plastic or metallic rod. The elongated member 20 could also be a resiliently elastic cord. Artificial or natural fiber ropes or strings could be used. In the exemplary embodiment shown in FIG. 6, the elongated member 20 is a telescoping rod 40. Also as shown in FIG. 6, the support ring 12 can include adjustable segments 42 to permit selective alteration of the diameter of the support ring 12 to support water saucers 16 of different sizes. These adjustable segments 42 could be connected in a known manner, such as by elastic connecting pieces disposed inside and connecting hollow ring segments.

In one possible embodiment the support ring 12 includes a friction surface to grip a water saucer 16. The friction surface could be a gripping elastomer or plastic material. While the hanging plant water saucer support assembly 10 is to be used with an existing water saucer 16, in one possible embodiment the hanging plant water saucer support assembly 10 further includes a water saucer 16 designed to fit into the support ring 12 to form a complete kit to be sold as a unit for use with any hanging plant 70.

FIGS. 4 and 5 show the hanging plant water saucer support assembly 10 in use with a hanging plant 70. To install the hanging plant water saucer support assembly 10, the user places a water saucer 16 in the support ring 12. The user then hangs the support ring 12 from the hanging plant 70 in the manner shown with the water saucer 16 positioned below the pot 74. The water saucer 16 can now catch water leaking out through the bottom or over the sides of the pot 74.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A hanging plant water saucer support assembly comprising:
a support ring configured to hold a water saucer by an outer rim thereof; and
a plurality of hanger assemblies, each comprising an elongated member, a first connecting device disposed at a first end of said elongated member and detachably connecting said support ring and said elongated member, and a second connecting device disposed at a second end of said elongated member and configured to detachably connect to a hanging plant to suspend said support ring and a water saucer held thereby from a hanging plant adjacent a bottom portion thereof to catch water;
wherein said second connecting device comprises a hook structure configured to hang on said hanging plant, wherein said hook structure comprises a round hook defining a partial circle extending greater than 270 degrees such that the round hook is configured to hook onto a support wire or rope of a hanging structure attached to an upper portion of a pot of a hanging plant.

2. The hanging plant water saucer support assembly of claim 1, wherein said support ring comprises adjustable segments to permit selective alteration of the diameter of said support ring to support water saucers of different sizes.

3. The hanging plant water saucer support assembly of claim 1, wherein said support ring comprises a friction surface to grip a water saucer.

4. The hanging plant water saucer support assembly of claim 1, wherein said first connecting device comprises a first connecting member attached to said support ring and a second connecting member attached to said first end of said elongated member.

5. The hanging plant water saucer support assembly of claim 4, wherein said first connecting member comprises a post and said second connecting member comprises a clip structure configured to detachably and pivotably clip onto said post.

6. (canceled)

7. (canceled)

8. The hanging plant water saucer support assembly of claim 1, wherein said elongated member comprises a plastic or metallic rod.

9. The hanging plant water saucer support assembly of claim 1, wherein said elongated member comprises a resiliently elastic cord.

10. The hanging plant water saucer support assembly of claim 1, wherein said elongated member comprises a telescoping rod.

11. The hanging plant water saucer support assembly of claim 1, wherein the hanging plant water saucer support assembly further comprises a water saucer configured to fit into said support ring.

12. A hanging plant water saucer support assembly comprising:
a support ring configured to hold a water saucer by an outer rim thereof, wherein:
said support ring comprises adjustable segments to permit selective alteration of the diameter of said support ring to support water saucers of different sizes,
said support ring comprises a friction surface to grip a water saucer; and
a plurality of hanger assemblies, each comprising an elongated member, a first connecting device disposed at a first end of said elongated member and detachably connecting said support ring and said elongated member, and a second connecting device disposed at a second end of said elongated member and configured to detachably connect to a hanging plant to suspend said support ring and a water saucer held thereby from a hanging plant adjacent a bottom portion thereof to catch water, wherein:
said first connecting device comprises a first connecting member attached to said support ring and a second connecting member attached to said first end of said elongated member, wherein said first connecting member comprises a post and said second connecting member comprises a clip structure configured to detachably and pivotably clip onto said post,
said second connecting device comprises a hook structure configured to hang on said hanging plant, wherein said hook structure comprises a round hook defining a partial circle extending greater than 270 degrees such that configured to hook onto a support wire or rope of a hanging structure attached to an upper portion of a pot of a hanging plant.

13. The hanging plant water saucer support assembly of claim 12, wherein said elongated member comprises a plastic or metallic rod.

14. The hanging plant water saucer support assembly of claim 12, wherein said elongated member comprises a resiliently elastic cord.

15. The hanging plant water saucer support assembly of claim 12, wherein said elongated member comprises a telescoping rod.

16. The hanging plant water saucer support assembly of claim 12, wherein the hanging plant water saucer support assembly further comprises a water saucer configured to fit into said support ring.
